(19) United States
(12) Patent Application Publication
(10) Pub. No.: US 2012/0125171 A1
(43) Pub. Date: May 24, 2012

(54) BORER FOR AN OSCILLATING TOOL

(75) Inventors: Liang Chen, Nanjing (CN); Hongtao Zhou, Nanjing (CN); Jinhua Wu, Nanjing (CN)

(73) Assignee: CHERVON (HK) LIMITED, Wanchai (HK)

(21) Appl. No.: 13/297,350

(22) Filed: Nov. 16, 2011

(30) Foreign Application Priority Data
Nov. 24, 2010 (CN) 201010574806.3

(51) Int. Cl. B26D 1/45; B23Q 5/02

(52) U.S. Cl. 83/610; 83/651

(57) ABSTRACT

A borer for forming holes in a workpiece has a fastening portion for mounting on an oscillating tool and a cutter which is connected with the fastening portion. The cutter is driven in a vibrating manner by the oscillating tool such that a feeding direction of the cutter is substantially parallel to a longitudinal axis about which the borer is driven in a vibrating manner.

### RELATED APPLICATION DATA

This application claims the benefit of CN 201010574806.3, filed on Nov. 24, 2010, the disclosure of which is incorporated herein by reference in its entirety.

### BACKGROUND

The subject disclosure relates to power tools and, more particularly, relates to a borer for a power tool in which the power output shaft oscillates back and forth in a small deflection angle at a high frequency to output power to drive a tool mounted thereon to perform operations of removing materials in a vibrating manner.

Oscillating tools, also known as multifunctional tools, which have various functions according to the different types of accessories mounted on their working head, such as the blades for sawing, the sanding plates for grinding and the like, are generally known. The working principle of an oscillating tool is that an oscillating driver drives the accessory mounted on its working head in a small deflection angle at a high frequency so as to perform operations of removing materials.

Oscillating tools mounted with saw blades are widely used for sawing various sheet materials, tube products, and the like, as such tools have the advantage of having high cutting efficiency and ease of operation, i.e., they may be conveniently used in many situations. However, since the saw blades of such existing oscillating tools for sawing are generally plate-shape saw blades having straight cutting edges, processing a hole requires many cutting steps, is inconvenient, and is relatively inefficient.

A saw blade used in connection with a hole saw known in the art makes rotational movement and a drill bit is fastened at the center of the saw blade of the hole saw for centering the saw blade. This hole saw blade is mounted on power tools such as an electric drill and the like which outputs the power in rotating manner so that a hole can be processed at one time with high efficiency. However, a hole saw blade is generally configured only with a circular section due to the limitation of its rotating output manner, and thus is only applicable for processing a circular hole, i.e., it is unable to process those holes of which the shape changes abruptly and transits non-smoothly.

### SUMMARY

To overcome the deficiencies of the above prior art, the below describes a borer for an oscillating tool. Since the oscillating tool drives the accessories in an oscillating manner, which is different from the rotating movement of the output of an electric drill and the like, if the oscillating tool is mounted with the subject borer having a section shape which is not limited to the circular shape, e.g., a triangle, quadrangle or even pentacle shape, it will be able to process more profiled holes. More particularly, the following describes a borer for an oscillating tool, comprising a fastening portion which has a receiver for mounting on the oscillating tool, the receiver defining a longitudinal axis about which the borer is driven in a vibrating manner, and a cutter which is connected with the fastening portion and has a material processing area, wherein the feeding direction of the cutter is substantially parallel to the longitudinal axis. The material processing area of the cutter may be substantially closed in circumferential direction, particularly where the circumferential direction is about the longitudinal axis of the borer, and/or may be constructed to include at least one substantially straight portion. The material processing area may be constructed as an area for sawing, grinding or cutting and may be constructed as a triangle, square, pentacle, or other shape.

A localizer having a locating end protrudable from the bottom edge of the material processing area of the cutter may also be included. A first spring element may then be provided to act on the localizer so that the localizer tends to bias towards the locating end.

A pushing out element may also be provided to push out the workpiece remaining in the cutter after processing. The pushing out element may comprises a second spring element of which one end is fixedly connected to the borer or fixedly connected to a flange mated with the output shaft and another end can be freely hang out of the bottom edge of the material processing area of the cutter.

### BRIEF DESCRIPTION OF THE DRAWINGS

FIG. 1 is a schematic view of an oscillating tool and an exemplary borer mounted at the end of its output shaft constructed according to the description that follows;

FIG. 2 is a schematic view illustrating a spring element for pushing out the workpiece integral with the cutter and a central localizer when the cutter comes in contact with the workpiece;

FIG. 3 is a schematic view illustrating the spring element for pushing out the workpiece integral with the cutter and the central localizer when the cutter has cut through the workpiece;

FIG. 4 is a schematic view illustrating that the spring element for pushing out the workpiece integral with the cutter and an inoperative central localizer when the cutter comes in contact with the workpiece;

FIG. 5 is a schematic view illustrating that the spring element for pushing out the workpiece is integral with the cutter and an inoperative central localizer when the cutter has cut through the workpiece;

FIG. 6 is a schematic view of a further exemplary embodiment wherein the spring element for pushing out the workpiece is integral with a lower flange; and

FIGS. 7, 8, 9 are respectively a schematic view of triangular, circular, and square accessory of the cutter.

### DETAILED DESCRIPTION

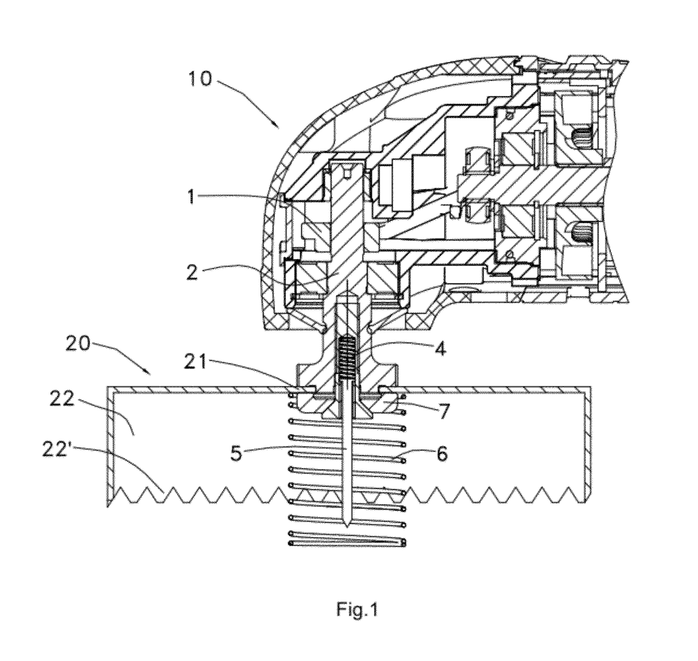

As illustrated in FIG. 1 to FIG. 6, a power tool 10 is provided to drive a working element in an oscillating manner to process a workpiece 8. An output shaft 2 is supported on the housing of a working head area of the power tool 10 and is driven by a vibrating bracket 1 to oscillate back and forth about its longitudinal axis in a small deflection angle with high frequency. A borer 20 is mounted on an end of the output shaft 2.

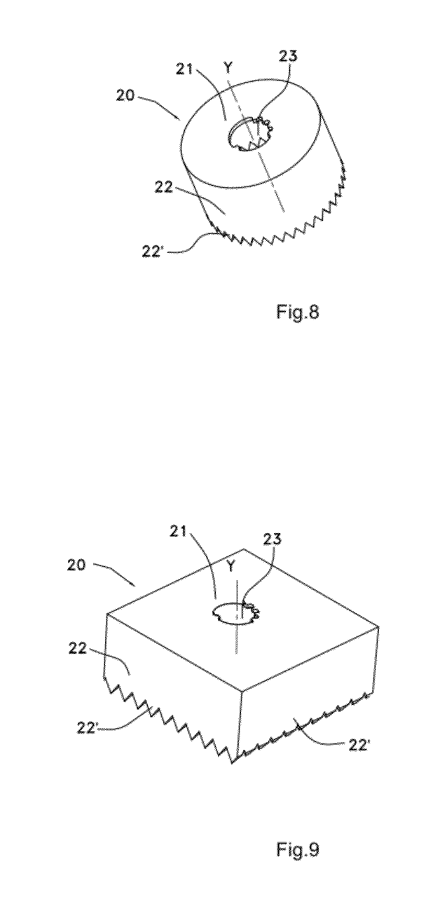

With reference to FIGS. 7-9, the borer 20 includes a fastening portion 21 having a receiver 23 for mounting on the oscillating tool 10. The receiver 23 defines a longitudinal axis Y. The borer 20 can be driven in a vibrating manner about the longitudinal axis Y. The fastening portion 21 is connected with a hollow cutter 22 having a material processing area 22′. The feeding direction of the cutter 22 is substantially parallel to the longitudinal axis Y. The cutter 22 can be constructed as an accessory by which square holes, circular holes and profiled holes such as pentacle, triangle and the other can substantially be bored.

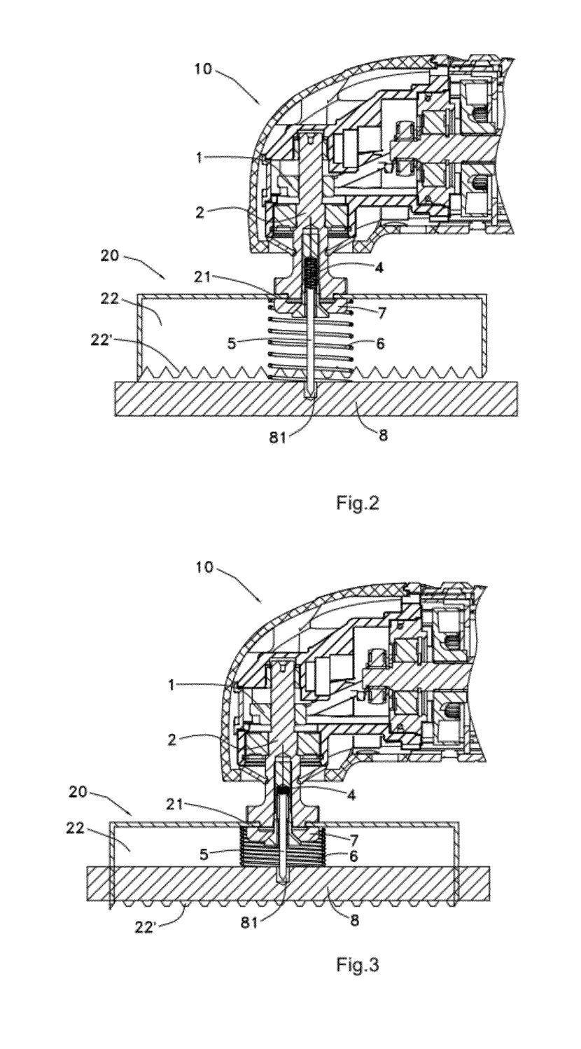

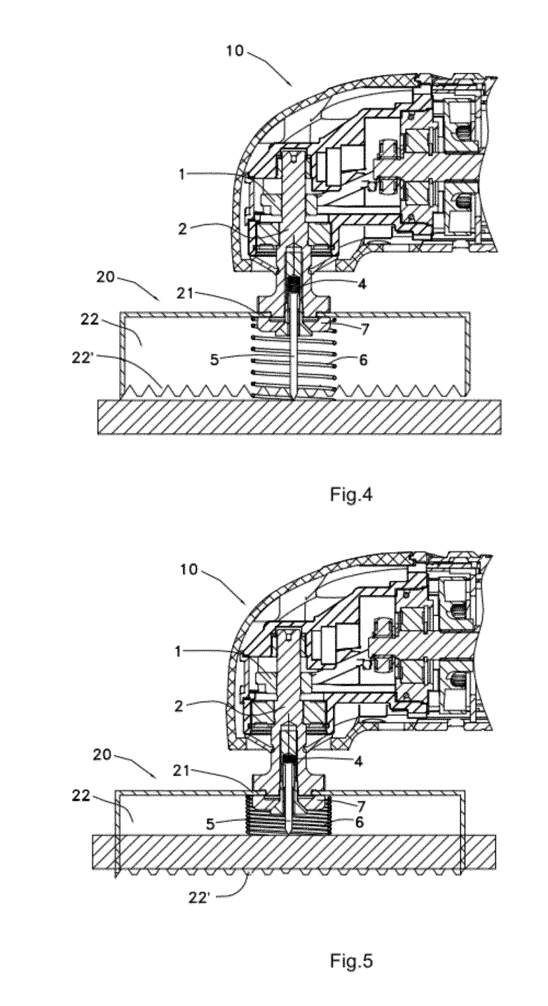

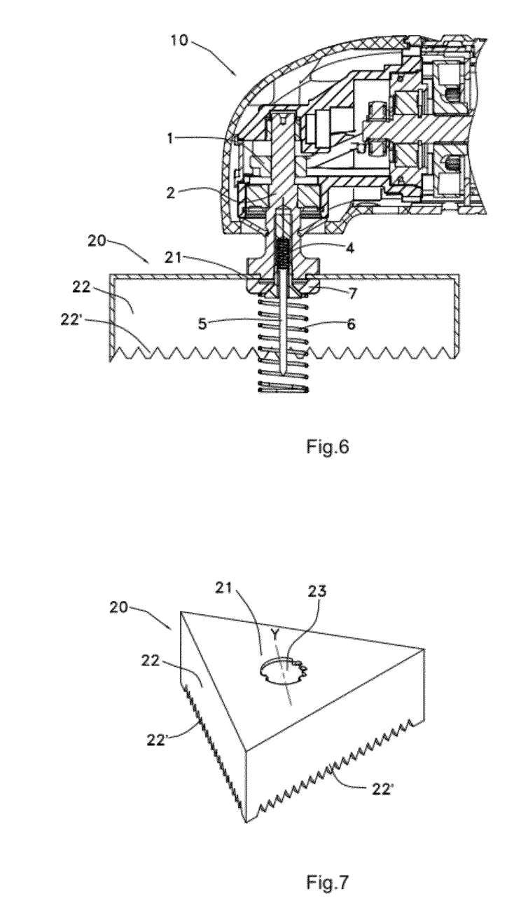

The oscillating tool 10 can be provided with a localizer 5 for locating when the borer 20 is boring a hole. The localizer 5 acts as a centering device, i.e., a centre, and a spring 4 acts on the upper end of the localizer 5. When the spring 4 is in an uncompressed state, the lower end of the centre can protrude out of the bottom edge of the material processing area 22 ′ of the cutter 22. Both the localizer 5 and the spring 4 are mounted within the central holes of the output shaft 2 and a flange 7. With reference to FIG. 2 and FIG. 3, when there is a drilled hole 81 on the surface of the workpiece 8, the central localizer 5 can be inserted into the hole 81 to serve for locating the device. With reference to FIG. 4 and FIG. 5, when there is no drilled hole 81 on the surface of the workpiece 8, the localizer 5 can be retracted freely, without affecting the processing of the cutter to the workpiece. The oscillating tool 10 of the present invention can also be provided with a pushing out element 6 for pushing out the workpiece remaining in the cutter 22 of the borer 20 after processing. The pushing out element 6 is placed in the cutter, which may be a spring with one end fixedly connected to the borer (see FIG. 1) or fixedly connected to the flange 7 mated with the output shaft 2 (see FIG. 6), and with another end freely hanging out of the bottom edge of the material processing area 22′of the cutter 22.

The oscillating tool and the borer used on the oscillating tool disclosed are not, however, intended to be limited to the illustrative examples provided. Rather, various alternatives may be arrived at by those of ordinary skill upon consideration of the teachings set forth herein. For example, to bore holes on the workpiece 8, the material processing area 22′ of the cutter 22 on the oscillating tool 10 is not required to be completely closed in the circumferential direction, and it can also achieve the aim of boring holes in the case that there is a little gap in the area 22′. Since the oscillating tool oscillates back and forth about the axis, and it can also saw the area of the workpiece that is in this gap, as long as the deflection angle is slightly bigger than this gap. Furthermore, the cutter 22 having the material processing area 22′ closed in circumferential direction may be moved not about the longitudinal axis Y, but about an axis parallel to the longitudinal axis Y. The spring used as the pushing out element 6 may directly abut against the borer 20 or the flange 7, without being fixedly connected with the borer 20 or the flange 7 as illustrated. Yet further, the material processing area 22′ of the cutter 22 can be constructed as an area for sawing, grinding or cutting, for example by using saw teeth, sanding disc, blade and the like. Accordingly, all obvious changes, substitutes or amendments to the shape and position of the components described herein are intended to fall within the protection scope set forth in the claims which follow.

What is claimed is:

1. A borer for an oscillating tool, comprising:
a fastening portion which has a receiver for mounting on the oscillating tool, the receiver defining a longitudinal axis about which the borer is driven in a vibrating manner; and
a cutter which is connected with the fastening portion and has a material processing area, wherein a feeding direction of the cutter is substantially parallel to the longitudinal axis.

2. A borer for an oscillating tool according to claim 1, wherein the material processing area of the cutter is substantially closed in a circumferential direction.

3. A borer for an oscillating tool according to claim 2, wherein the material processing area is substantially closed in the circumferential direction about the longitudinal axis.

4. A borer for an oscillating tool according to claim 1, wherein the material processing area is constructed as an area for sawing, grinding or cutting.

5. A borer for an oscillating tool according to claim 2, wherein the material processing area is circumferentially constructed to include at least one substantially straight portion.

6. A borer for an oscillating tool according to claim 5, wherein the material processing area is circumferentially constructed as triangle, square or pentacle.

7. An oscillating tool, comprising:
a vibration driver having an output shaft which can be driven in a vibrating manner with respect to its longitudinal axis; and
a borer comprised of a fastening portion which has a receiver for mounting on the oscillating tool, the receiver defining a longitudinal axis about which the borer is driven in a vibrating manner; and a cutter which is connected with the fastening portion and has a material processing area, wherein a feeding direction of the cutter is substantially parallel to the longitudinal axis.

8. An oscillating tool according to claim 7, further comprising a localizer with a locating end protrudable from the bottom edge of the material processing area of the cutter.

9. An oscillating tool according to claim 8, wherein a first spring element acts on the localizer so that the localizer tends to bias towards the locating end.

10. An oscillating tool according to claim 7, further comprising a pushing out element arranged within the cutter for pushing out the workpiece remaining in the cutter after processing.

11. An oscillating tool according to claim 10, wherein the pushing out element comprises a second spring element of which one end is fixedly connected to the borer or fixedly connected to a flange mated with the output shaft and another end can be freely hang out of the bottom edge of the material processing area of the cutter
